(19) United States
(12) Patent Application Publication
(10) Pub. No.: US 2026/0267769 A1
(43) Pub. Date: Sep. 10, 2026

(54) SYSTEMS, METHODS, AND SOFTWARE FOR ENHANCED ANOMALY DETECTION

(71) Applicant: Mitsubishi Electric Research Laboratories, Inc., Cambridge, MA (US)

(72) Inventors: Kevin Wilkinghoff, Brookline, MA (US); Haici Yang, Bloomington, MA (US); Janek Ebbers, Cambridge, MA (US); François Germain, Quincy, MA (US); Gordon Wichern, Boston, MA (US); Jonathan Le Roux, Arlington, MA (US)

(21) Appl. No.: 19/069,605

(22) Filed: Mar. 4, 2025

(51) Int. Cl. G06F 11/30; G06N 20/00

(52) U.S. Cl. CPC G06F 11/3466; G06F 2201/81

(57) ABSTRACT

A computer-implemented method includes collecting a test data sample from a monitored environment. For each sample in a set of reference data samples associated with the monitored environment, the method computes a scaling factor based on distances between the reference sample and other samples of the reference data samples. Then, a scaled distance to the test data sample is computed for each of the reference data samples based on their respective scaling factors. A nearest one of the reference data samples is identified based on the scaled distances, and the scaled distance to nearest reference data sample is compared to an anomalous distance threshold. An anomaly detection result may be output that is determined based on whether the scaled distance exceeds an anomalous distance threshold.

### TECHNICAL FIELD

Aspects of the disclosure are related to the field of industrial computing hardware and software, and in particular, to anomaly detection software and systems.

### BACKGROUND

In distance-based anomaly detection, the anomalies are detected by comparing the distances between a test data sample and normal training data samples. The underlying idea is that normal data points will generally be close to each other, forming dense clusters in the feature space. If a new (test) sample is far from these clusters, it may be considered an anomaly.

The distance-based anomaly detection typically includes two major steps. First, for each test data sample, compute the distance to training data points. Common distance metrics include cosine similarity, as well as Euclidean or Manhattan distance. Next, set a threshold distance based on the spread of the training data. If the distance between the test sample and the closest training points is beyond this threshold, the test sample is flagged as an anomaly.

Various variations of this basic two-step approach are possible. For example, some methods, like k-nearest neighbors (k-NN), can also be used where a test sample's anomaly score is based on the average distance to its k-nearest neighbors in the training data. Other methods, like local outlier factor (LOF) use different distance-based measures that consider the density of the neighboring points.

However, the two-step distance-based anomaly detection may fail when the training data samples are not homogeneous-such as when they have varying noise levels or are drawn from different domains (like a source domain with abundant data and a target domain with limited data). In those situations, there are a few strategies to make distance-based anomaly detection more effective and robust. These strategies are based on domain adaptation, projecting data into a more uniform latent space, or varying thresholds for different domains/clusters of data. However, all these strategies require specific domain knowledge and adaptation and vary from one practical application to another. Furthermore, if the domain of the test sample is not known a-priori, it is not possible to use domain specific thresholds without building a domain classifier, which may be quite difficult, especially when some domains have very limited data.

For example, the latent space found for one practical application, such as anomaly detection of a drilling machine, may not work for another application such as autonomous assembly operation. Notably, finding such a latent space is a challenging technical problem. Similarly, a set of thresholds selected for different clusters of training data samples may become suboptimal when new training data samples, possibly belonging to other clusters, arrive.

### SUMMARY

Technology is disclosed herein that improves the field of anomaly detection by enhancing the accuracy and reliability of detecting deviations from normal conditions in monitored environments, and with respect to the comparison of distances between a test data sample and non-homogenous reference samples with a uniform anomaly threshold predetermined for the entire feature space of the reference data samples.

In an implementation, a computer-implemented method includes collecting a test data sample from a monitored environment. For each sample in a set of reference data samples associated with the monitored environment, the method computes a scaling factor based on distances between the reference sample and other samples of the reference data samples. Then, a scaled distance to the test data sample is computed for each of the reference data samples based on their respective scaling factors. A nearest one of the reference data samples is identified based on the scaled distances, and the scaled distance to nearest reference data sample is compared to an anomalous distance threshold. An anomaly detection result may be output that is determined based on whether the scaled distance exceeds an anomalous distance threshold.

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment with enhanced anomaly detection in an implementation.

FIG. 2 illustrates an anomaly detection process in an implementation, which may be employed in the context of the operational environment of FIG. 1.

FIG. 3 illustrates an anomaly detection system in an implementation.

FIG. 4 illustrates a training system in an implementation, which may be employed to train one or more components of the anomaly detection system of FIG. 3.

FIGS. 5A-5D illustrate various implementations of the anomaly detection process illustrated in FIG. 2

FIG. 6 illustrates a computing system suitable for implementing the various operational environments, architectures, processes, scenarios, and sequences discussed below with respect to the other Figures.

### DETAILED DESCRIPTION

As automation increases, algorithms that use sensors (e.g., microphones) to monitor machine performance and health are increasing. This allows for the automation of tasks formerly performed by highly skilled human operators. In light of this, there has been a surge of recent interest in anomalous sound detection where automated algorithms determine whether sound produced during machine operation is normal or anomalous. These approaches work in increasingly difficult problem setups where only normal data is available for training, and domain shifts cause changes in the sound signal unrelated to the presence or absence of anomalous sound.

While most data collection is intrinsically costly (at least with the current state of technology), anomaly detection data, by its nature, is particularly difficult to collect. Indeed, collecting substantial and diverse anomalous data requires either waiting for the target machines to break down, or to purposefully damage often pricey equipment. Generating synthetic anomalous data is also often very unpractical, as many anomalies are essentially of unknown nature. Hence, a very desirable (if not necessary) property of any practical machine-learning-based approach for anomaly detection would be to rely exclusively on data corresponding to the normal operation of the machine when training.

Another desirable property is for the approach to be able to handle so-called domain shifts where something unrelated to anomaly changes (e.g., in the case of sound, the background noise of the factory, etc.). The idea then is to allow the system to learn about the new “domain” with access to a very limited amount of data from that domain, either at training or, harder, at inference time.

Anomalous sound detection has been receiving increasing attention in recent years and two major types of methods have emerged: 1) Autoencoder-based methods; and 2) Outlier-exposure-based methods. With Autoencoder-based methods, a system is trained to encode audio with very few numbers and then decode those few numbers back into audio. Training is meant to make that system capable of doing so well with the (normal) training data. Then, when later presented with an unknown normal sound, the system should be able to encode and decode it mostly successfully, while it should fail for an unknown anomalous sound. An anomaly can then be detected by setting a threshold on the reconstruction imperfection to trigger an anomaly detection.

With Outlier-exposure-based methods, a system is trained to classify some ancillary aspect of normal data (e.g., type of machine, model number, running speed, running mode). The system outputs a set of numbers (embeddings) for each audio snippet and learns to organize them in such a way that those ancillary aspects can be identified through some geometric criterion based on their respective locations. Later, when an unknown normal sound is presented with some known ancillary attributes, the system is expected to output an associated embedding whose location match what would be expected, based on the location of embeddings collected from training samples with the same ancillary attributes. On the other hand, anomalous samples should generate embeddings whose location does not match what would be expected based on its known ancillary attributes.

The enhanced anomaly detection disclosed herein is based on the outlier exposure methods described above. Generally, outlier exposure methods provide better quality for anomaly detection in most situations. However, they are still insufficient in one important and practically relevant scenario. This scenario is illustrated well in terms of anomalous sound detection systems, where a microphone sensor is used to monitor machine health. Note, however, that the disclosed method is applicable to other types of sensors and environments used for anomaly detection as well.

Consider an anomaly detection system monitoring a machine in a noisy factory. The typical background noise in the factory includes sounds such as electrical hum and beeping. All samples of the machine operating normally under these conditions are referred to as the source domain. However, a few times per day, a forklift drives past the microphone, changing the background noise profile, which may be referred to as the target domain. Other examples include different machine settings, e.g., low speed motor operation (source domain) or high-speed motor operation (target domain); different microphones, e.g., motor recorded with expensive microphone (source domain), or motor recorded with cheap microphone (target domain); and different background noise, e.g., a motor recorded with drilling sound as the predominant background noise (source domain) or a motor recorded with forklift sound as the predominant background noise (target domain).

A goal then is for the system to perform well in both the source domain and the target domain, even though there may be significantly more training data available for the source domain. A challenge is to teach the system not to be sensitive to the target domain noise, which may otherwise cause many false alarms.

An anomaly detection system should be able to generalize well to unseen target domains by providing only a few target domain samples to define how normal data samples sound without needing to re-train or modify the system. In contrast to the source domain, for which many normal training samples are available, accurately estimating the underlying distribution of normal data after a domain shift based on very few samples is challenging. This usually leads to a mismatch between the corresponding anomaly scores of the source and target domains and significantly reduces performance. The proposed distance normalization technique disclosed herein provides a simple and effective remedy to reduce this mismatch between source and target domains.

The proposed technique normalizes the distance between test samples and reference samples based on the local neighborhood around the reference sample. Because some normal training samples will be close to many other training data samples (source domain), and other normal training samples may be farther from other training samples (target domain), the proposed technique normalizes the distance based on this local neighborhood. This approach improves confidence in the calculated anomaly score, considering the typical distance between the reference sample and its local neighborhood.

A well-known approach in the anomaly detection literature for normalizing a point based on its local neighborhood is the local outlier factor (LOF). However, LOF is insufficient for situations with abundant training data from the source domain but sparse data from the target domain, especially when the operational domain at test time is unknown. Using LOF can increase domain mismatch and degrade performance. For a normal test sample of the source domain, the density of the sample and its nearest neighbors are similar due to densely clustered normal data. In contrast, for a normal test sample of the target domain, clusters are sparser, leading to strong differences in local densities and anomaly scores, increasing domain mismatch.

The proposed distance normalization technique addresses this issue. For a test sample equidistant between two training reference samples, one in the source domain (dense cluster) and another in the target domain (sparse cluster), normalization adjusts distances based on local neighborhoods. Source domain nearest neighbors, close to other samples, are pushed further away from the test sample, while target domain nearest neighbors, with larger average distances, are pushed closer. This cautious approach to declaring anomalies in the target domain accounts for typical distances between samples. A goal is to find the optimal threshold for separating normal and anomalous data, detecting as many true anomalies as possible while minimizing false alarms. However, optimal thresholds differ between source and target domains.

In an example of extracting an embedding vector from a sound signal, spectral features are computed from the sound signal. The features could be the discrete Fourier transform of the entire audio signal, the short-time Fourier transform (STFT), or a combination of both. To improve noise robustness, the mean of the STFT for each frequency band may also be subtracted. These spectral features are then input into an embedding extraction network, which converts them into a single N-dimensional embedding vector. This neural network is typically a convolutional neural network.

The process of training the embedding extraction neural network begins with an audio file and associated metadata, such as machine type, operating load, and recording location. Data augmentation techniques, like random gain shifts, equalization, time stretching, pitch shifting, or mix-up, are applied to increase the variety of training data. Spectral features are computed and input into the embedding extraction network, producing an embedding. The embedding goes into a metadata prediction network, which predicts the metadata using a single classification layer. The loss function then compares the ground truth and predicted metadata, using cross-entropy for discrete attributes or mean squared error for continuous attributes, to optimize the network's performance.

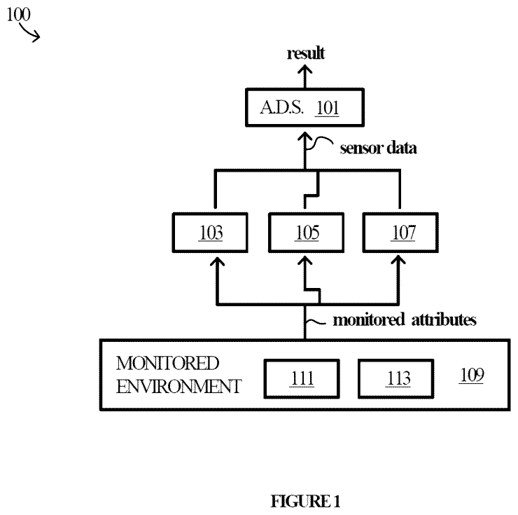

Turning now to the figures, FIG. 1 illustrates an operational environment 100 in an implementation. Operational environment 100 includes anomaly detection system 101 (ADS), one or more sensors-represented by sensor 103, sensor 105, and sensor 107, and a monitored environment 109. Monitored environment 109 includes one or more elements monitored by the sensor(s), represented by element 111 and element 113.

Monitored environment 109 represents a specific physical or digital space in which the sensors are deployed to observe and collect data. The environment may encompass all or portions of areas, conditions, and variables that are being continuously or periodically monitored for anomalies or significant changes. Examples of monitored environment 109 include industrial plants, data centers, smart homes, healthcare facilities, public transportation systems, environmental monitoring stations, and retail stores. Examples of element 111 and element 113 in monitored environment 109 include: in an industrial plant, conveyor belts and pressure gauges; in a data center, servers and cooling systems; in a smart home, thermostats and security cameras; in a healthcare facility, patient vital signs monitors and infusion pumps; in a public transportation system, trains and ticketing systems; in an environmental monitoring station, air quality sensors and weather stations; and in a retail store, inventory sensors and point-of-sale systems. Each of these elements is monitored to ensure the efficient and safe operation of the respective environments.

Sensors 103, 105, and 107 represent devices designed to detect and measure various physical phenomena within a monitored environment. They can encompass a wide range of sensor types, each with specific functions. Examples include acoustic sensors, which capture sound waves and convert them into electrical signals for analysis; tachometers, which measure the rotational speed of an object; and accelerometers, which detect changes in acceleration or movement. These sensors play a crucial role in collecting data on different aspects of monitored environment 109, allowing for accurate and effective anomaly detection.

ADS 101 represents an advanced computational framework designed to identify deviations from expected patterns within monitored environment 109. ADS 101 leverages machine learning algorithms and statistical analysis to detect abnormal behaviors or conditions that may indicate potential issues or anomalies. ADS 101 processes data collected from various sensors, such as acoustic sensors, tachometers, and accelerometers, to monitor elements like machinery, network traffic, or environmental conditions. By continuously analyzing this data, the ADS 101 can promptly identify and alert operators to any anomalies, thereby enabling timely interventions and maintaining the optimal functioning of the monitored environment.

ADS 101 may be implemented with hardware, software, firmware, or any combination thereof, providing flexibility in its deployment to suit different operational requirements. Additionally, ADS 101 can be implemented in a stand-alone manner or integrated within the context of other systems or sub-systems in operational environment 100, offering further adaptability and seamless integration with existing infrastructures.

A hardware-based version of ADS 101 may be directly implemented in specialized chips or embedded systems to ensure real-time processing and low latency. A software-based version of ADS 101 may be deployed as an application running on general-purpose computers or servers, offering flexibility and ease of updates. A firmware-based version of ADS 101 may involve embedding the system in the firmware of devices, such as IoT devices or industrial controllers, balancing performance and flexibility.

A hybrid approach may also be employed, combining hardware, software, and firmware components to leverage the strengths of each. Alternatively, or in addition, a cloud-based version of ADS 101 may be deployed in cloud environments, allowing for scalable and flexible deployment, as well as access to advanced machine learning and data analytics tools. In edge computing scenarios, ADS 101 may be deployed closer to the data source, such as on IoT devices or local servers, to reduce latency and bandwidth usage.

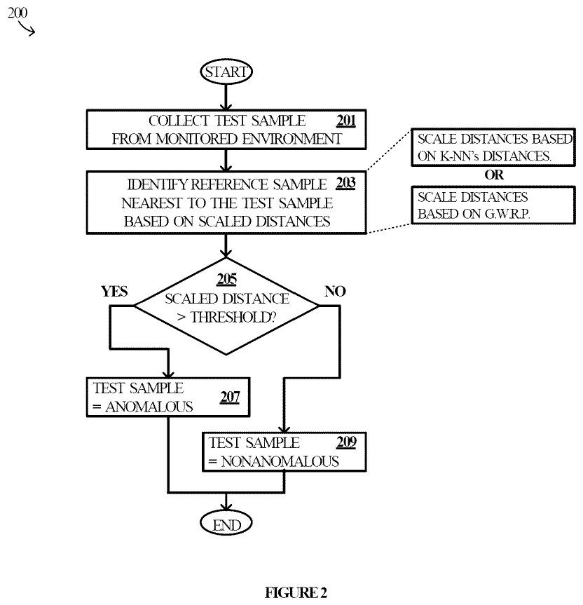

ADS 101 employs an anomaly detection process 200 illustrated in FIG. 2 to detect anomalies in monitored environment 109. When implemented via software and/or firmware, anomaly detection process 200 may be implemented in program instructions in the context of software, and/or firmware elements of ADS 101. The program instructions, when executed by one or more processing devices of one or more suitable computing devices, direct the one or more computing devices to operate as follows, referring to the steps of FIG. 2.

At step 201, the anomaly detection system collects a test data sample from the monitored environment. This involves capturing real-time data from sensors deployed throughout the environment, providing a current snapshot of its conditions. The collected sample serves as the basis for comparison against known reference data.

At step 203, the system identifies the reference data sample that is nearest to the test data sample from a set of reference data samples associated with the monitored environment. This set of reference data samples represents typical, expected, or historical states of the monitored environment. The nearest reference data sample is determined based on the similarity or distance between the test data sample and the reference samples, typically using a cosine distance measure and a scaling factor determined for each of the reference data samples.

More specifically, at runtime or prior to runtime (or a combination of both), a scaling factor is computed for each of the reference data samples based on the distances to a given reference data sample and others of the reference data samples. The scaling factor determined for each reference sample may then be applied to the cosine distance measure of the distance between the reference sample and the test data sample. This scaling accounts for the variability within the reference data set, resulting in a more contextually relevant measure of distance.

The scaling can be performed using one of at least two methods. In one (K-NN), the scaling factor is determined based on the K-nearest neighbors of the reference sample to the reference sample itself. The process involves identifying the K reference samples that are closest to the reference data sample, determining their cosine distances, and summing the cosine distances, resulting in a scaling factor for the reference data sample. The scaling factor may then be applied to the measured cosine distance between the test sample and the reference data sample (e.g., by dividing the cosine distance by the scaling factor). The following equation is exemplary of this technique and may be employed to calculate the scaled distance (or scaled anomaly score) from each reference data sample (y) to the test data sample (x).

$${A}_{scaled}^{k - NN} ( x , {X}_{ref} \vert K ) := {min}_{y ∈ {X}_{ref}} \frac{{A}_{co s} ( x , y )}{{\sum }_{k = 1}^{K} {A}_{co s} ( y , {y}_{k} )} ∈ {ℝ}_{+} , .$$

Alternatively, the scaling factors for the reference data samples may be computed using global weighted ranking pooling (GWRP). This involves assigning weights to the reference data samples based on their global ranking relative to a given reference sample. This further involves ordering all of the reference samples based on their relative distances to the reference sample, and then inversely weighting each of their cosine distances to the selected reference sample based on the determined order. For example, the distances of those of the reference samples closer to the selected reference sample carry more weight in the scaling computation than those of the reference samples that are further away from the selected reference sample. The weighted cosine distances may then be summed, resulting in a scaling factor for the given reference data sample. The scaling factor may then be applied to the measured cosine distance between the test sample and the reference data sample (e.g., by dividing the cosine distance by the scaling factor). The following equation is exemplary of this technique and may be employed to calculate the scaled distance (or scaled anomaly score) for each reference data sample (y) to the test data sample (x).

$${A}_{scaled}^{GWRP} ( x , {X}_{r e f} \vert r ) := {min}_{y ∈ {X}_{ref}} \frac{{A}_{co s} ( x , y )}{{\sum }_{k = 1}^{\vert {X}_{ref} \vert - 1} {A}_{co s} ( y , {y}_{k} ) \cdot {r}^{k - 1}} ∈ {ℝ}_{+} ,$$

The reference data samples may be a heterogeneous dataset that includes only normal data samples and excludes any anomalous data samples. The heterogeneous dataset may include source domain data samples and target domain data samples. The reference data samples may be reference embeddings produced by a machine learning model trained on the heterogeneous dataset to predict embeddings. The test data sample may also be an embedding generated by the machine learning model.

At step 205, the system checks whether the scaled distance exceeds a predefined anomalous distance threshold. This threshold represents the maximum acceptable deviation from normal conditions. If the scaled distance is greater than the threshold, it indicates a potential anomaly. If the scaled distance exceeds the threshold, at step 207, the system determines that the test sample is anomalous. This means that the current state deviates significantly from normal conditions, suggesting an irregularity that requires attention. If the scaled distance does not exceed the threshold, at step 209, the system determines that the test sample is non-anomalous. This indicates that the current state is within expected parameters and does not show any significant deviations. The system may then output an anomaly detection result based on the determination made in the previous steps. This result indicates whether the test sample is anomalous or non-anomalous. The result can then be used for further action, such as triggering alerts, interventions, or the like.

It may be appreciated that the scaled distances calculated in step 203 serve as anomaly scores, quantifying the deviation of a test data sample from the expected normal state represented by the reference data samples. This anomaly score is a useful metric for determining whether the test sample exhibits anomalous behavior. One advantage of this method is that a single threshold can be used to evaluate the scaled distance, regardless of whether the test sample falls within the source domain or the target domain. This is possible because the scaling process normalizes the distance measure, making it independent of specific domain characteristics. The use of a single threshold ensures consistency in anomaly detection across different domains, simplifies the decision-making process, and enhances the robustness of the method.

Furthermore, the main idea of the re-scaling performed by step 203 is that test samples that are very close to a reference sample are more likely to have a similar distance as the nearest neighbors of this reference sample. In contrast, test samples that are far away from the target distribution have a much higher distance to the closest reference samples than these samples have to their closest neighbors, and thus their corresponding anomaly scores will be higher after re-scaling.

It may be appreciated that k-NN and GWRP start from the same points (when K=1 and r=0), and work from different directions. K-NN directly picks a limited number of neighbors to consider, while giving them equal weights. GWRP, on the contrary, considers every data point in the domain, but emphasizes closer ones by imposing exponentially decreasing weights. In the end, they intersect when K in k-NN equals to the number of data points (k=N), and r=1.

It may be further appreciated that the proposed approach has several advantages. First, the anomaly scores are not directly related to the absolute distances between different samples as only relations between distances are considered. Thus, the domain mismatch between the distributions of anomaly scores is significantly reduced. Furthermore, no training or estimation of a distribution, which is difficult in high-dimensional spaces, is needed to compute an anomaly score because the scores effectively only depend on the distance to the local neighborhood of the closest reference sample of a test sample.

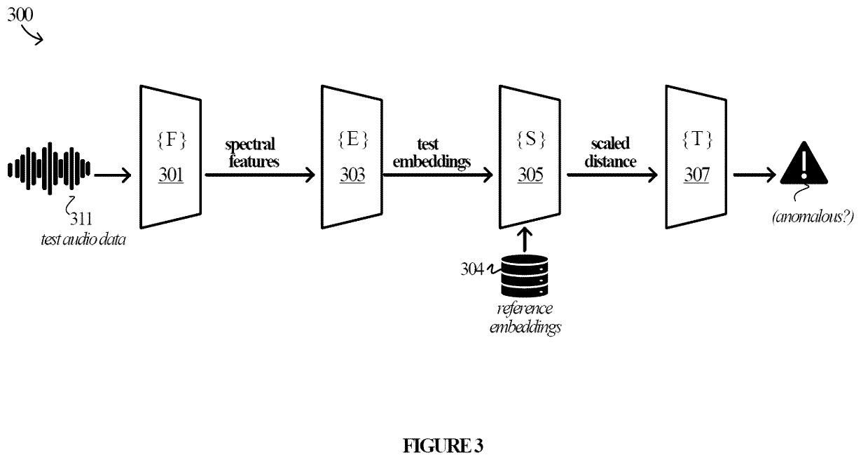

FIG. 3 illustrates an anomaly detection system 300 in an implementation. Anomaly detection system 300 is representative of a hardware, software, and/or firmware architecture for implementing anomaly detection system 101 in FIG. 1. Anomaly detection system 300 includes feature encoder 301, embedding function 303, scoring function 305, and threshold function 307.

Feature encoder 301 is responsible for encoding spectral features of input data, such as audio signals. It captures and processes the characteristics of the monitored environment, transforming raw signal data into a format suitable for further analysis. The encoded spectral features serve as the foundation for generating embeddings.

Embedding function 303 encodes the spectral features produced by the feature encoder 301 into test embeddings. These embeddings represent the input data in a lower-dimensional vector space, facilitating efficient comparison and analysis. The test embeddings encapsulate the essential characteristics of the input data, making them suitable for anomaly detection.

Scoring function 305 generates an anomaly score based on a test embedding for a test sample and a reference embedding that is nearest in vector space to the test embedding based on a scaled distance. It performs the method described above to generate a scaled distance (scaled anomaly score). This involves scaling the distance between the test data sample and the reference data sample using a scaling factor computed for the reference sample. Furthermore, the scaling factor is computed using techniques such as K-nearest neighbors (K-NNs) or global weighted ranking pooling. The resulting scaled distance quantifies the degree of deviation from normal conditions.

Threshold function 307 evaluates the scaled distance against a predefined threshold. If the scaled distance exceeds the threshold, the test sample is considered anomalous, indicating a significant deviation from normal patterns. If the scaled distance does not exceed the threshold, the test sample is deemed non-anomalous, indicating that it falls within expected parameters. This evaluation allows for the identification of anomalies based on a single, consistent criterion.

Anomaly detection system 300 is designed to process and analyze input data, such as audio signals, to detect anomalies in monitored environments. The following scenario assumes a factory setting where the system monitors the sound produced by a machine to ensure it operates correctly. The system continuously records the machine's sound as test audio data 311, which serves as the input for the anomaly detection process.

In operation, the process begins when test audio data 311 is introduced to feature encoder 301, which encodes the spectral features of the input audio signals. Feature encoder 301 captures and processes the characteristics of the monitored environment, converting raw audio signals into a format suitable for further analysis. Encoded spectral features form the basis for generating embeddings.

Spectral features from feature encoder 301 are then passed to embedding function 303. Embedding function 303 encodes the spectral features into test embeddings, representing the input audio data within a lower-dimensional vector space. The test embeddings encapsulate the essential characteristics of the audio signals, facilitating efficient comparison and subsequent anomaly detection. The lower-dimensional representation of the embeddings ensures manageable data processing.

Test embeddings generated by embedding function 303 are then fed into scoring function 305. Scoring function 305 calculates an anomaly score by comparing the test embedding with a reference embedding from the dataset of reference embeddings 304, which includes typical, expected, or historical states of the monitored environment. Scoring function 305 identifies the reference embedding nearest to the test embedding in vector space and computes the distance between them. The distance is then scaled using methods such as K-nearest neighbors (K-NNs) or global weighted ranking pooling, resulting in a scaled distance (scaled anomaly score). The scaled distance quantifies the degree of deviation from normal conditions.

Finally, the scaled distance produced by scoring function 305 is evaluated by threshold function 307 against a predefined threshold. If the scaled distance exceeds this threshold, the test sample is classified as anomalous, signifying a significant deviation from normal patterns. If the scaled distance does not exceed the threshold, the test sample is deemed non-anomalous, indicating it falls within expected parameters. Threshold function 307 enables anomaly detection system 300 to identify anomalies using a consistent criterion, regardless of whether the test sample originates from the source domain or target domain.

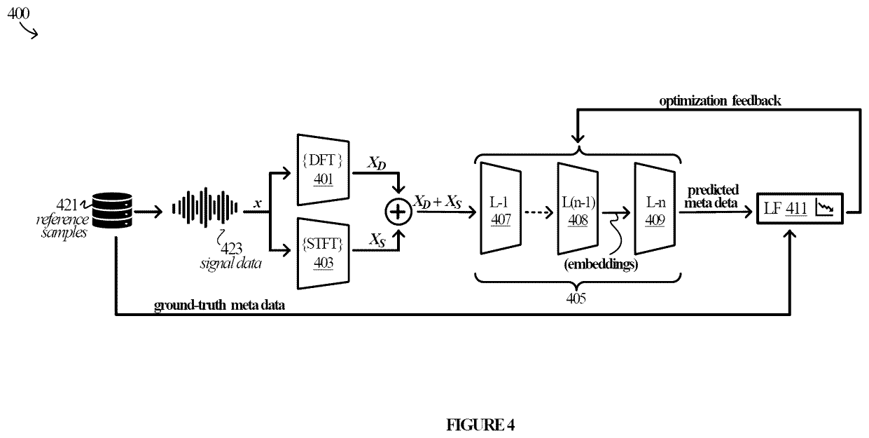

Embedding function 303 must be trained to produce accurate and useful embeddings. FIG. 4 illustrates a training system 400 for doing so. Training system 400 includes reference samples 421, from which signal data 423 is drawn; a DFT function 401, an STFT function 403, and an embedding network 405 that includes various layers including layer 407, layer 408, and layer 409. Finally, the system 400 includes a loss function 411. Signal data 423 for each sample of reference samples 421 is fed into each of DFT 401 and STFT 403, which each encode the signal data via a Fourier transform process. Each 256-dimension result is concatenated together into a 512-dimension result, which is input into embedding network 405. The input is processed through the layers 407, 408, 409, which output predicted meta data. However, between layer 408 and 409, layer 408 produces embeddings. Loss function 411 compares the predicted meta data to ground truth meta data in reference samples 421 and provides optimization feedback to embedding network 405 accordingly.

Reference samples 421 include typical, expected, or historical states of a monitored environment. From reference samples 421, signal data 423 is drawn. Signal data 423 represents the characteristics of the monitored environment and serves as the raw input for the training process. As mentioned, training system 400 also includes DFT function 401 and STFT function 403. Both functions encode the signal data via Fourier transform processes, each producing a 256-bit result. These 256-bit results are concatenated into a single 512-bit result, which is then fed into embedding network 405.

Embedding network 405 is a neural network (e.g., a convolution neural network, or CNN) comprising multiple layers: layer 407, layer 408, and layer 409. The embedding network processes the concatenated result through these layers to transform the input into a format suitable for predicting meta data. Layer 407 is the initial processing layer, while layer 408 is an intermediate layer that generates embeddings, which are lower-dimensional representations of the input data. These embeddings are used for subsequent anomaly detection. Layer 409 is the final layer that processes the embeddings to predict meta data.

To ensure the embeddings are accurate and useful, embedding network 405 is optimized using loss function 411. Loss function 411 compares the predicted meta data output by layer 409 to the ground truth meta data in reference samples 421. It evaluates the accuracy of the predictions and provides optimization feedback to embedding network 405, adjusting the network's parameters to improve performance and accuracy. This structured training process ensures that embedding function 303 produces precise and meaningful embeddings.

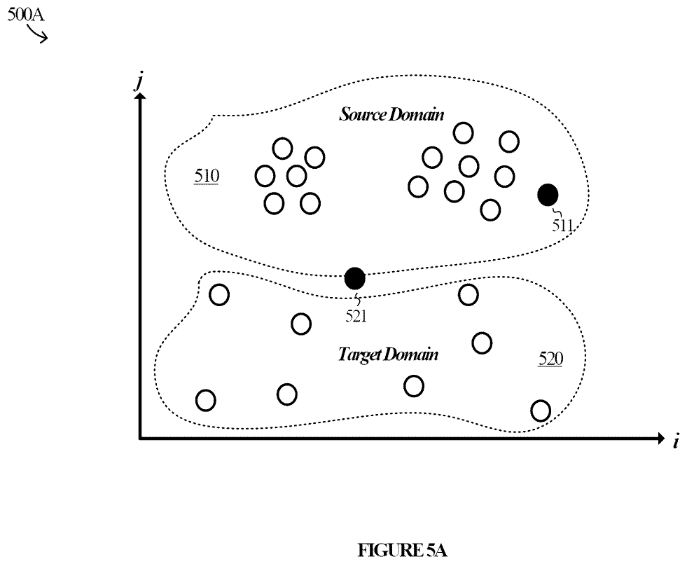

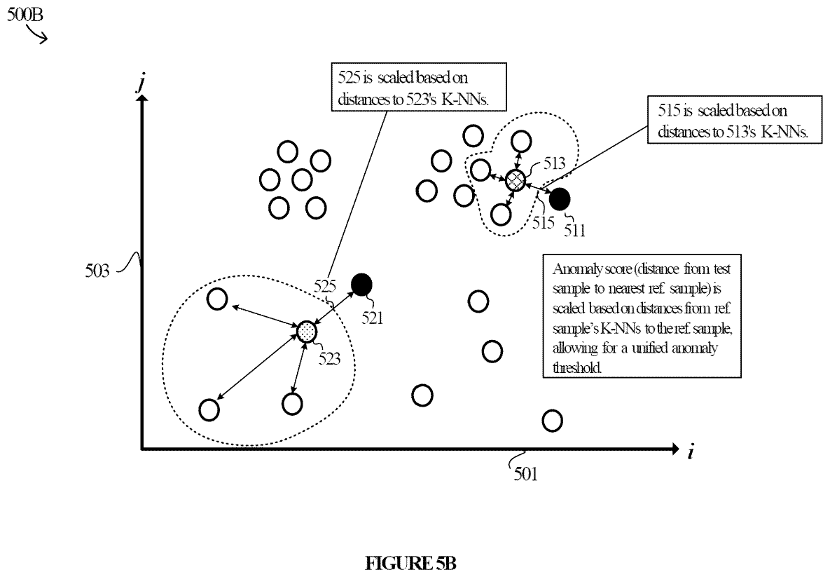

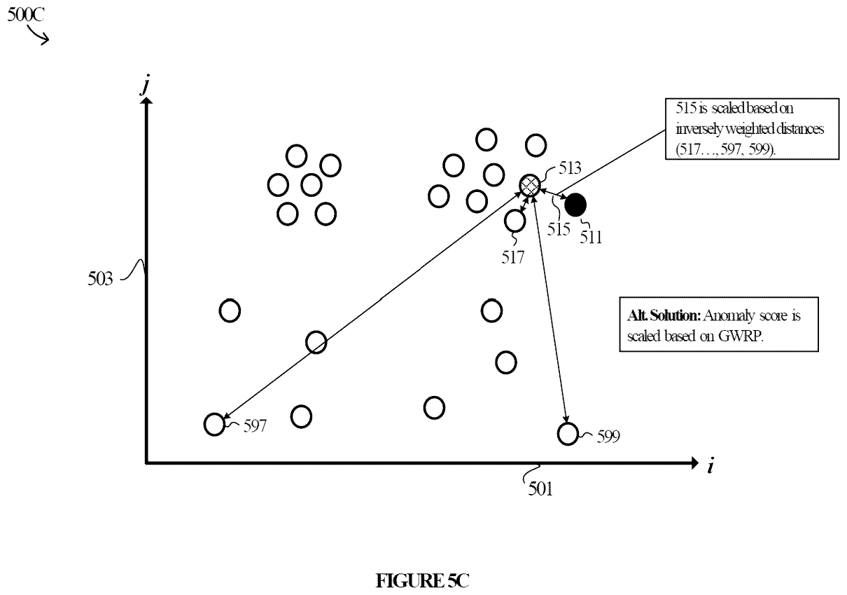

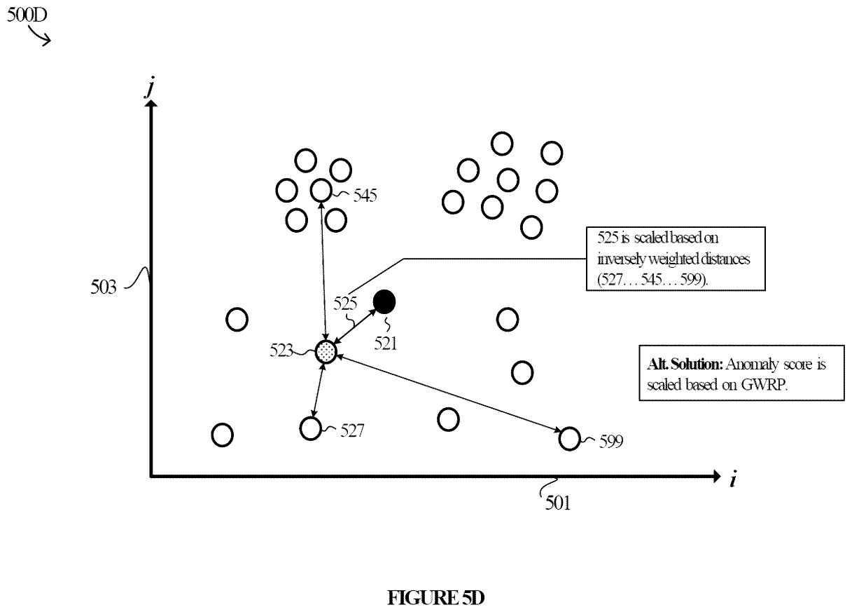

FIG. 5A illustrates an operational scenario 500A that involves a set of reference samples and two test samples within the context of anomaly detection. In this scenario, the two test samples are labeled as test sample 521 and test sample 511. The reference samples are categorized into two distinct groups: source domain 510 and target domain 520. These groups represent different sets of reference data, with source domain 510 typically comprising well-characterized and expected states, while target domain 520 may include data from a different but related operational context.

For illustrative purposes, the reference samples and test samples in this scenario are represented as two-dimensional points. However, in practical applications, these data points could have many more dimensions, capturing a wide array of features and characteristics relevant to the monitored environment. The two-dimensional representation simplifies the visualization and explanation of the scenario, but the underlying principles remain applicable to higher-dimensional data.

FIG. 5B illustrates operational scenario 500B, demonstrating the application of anomaly detection process 200 to test sample 511 and test sample 521. In this scenario, test sample 511 is located well within source region 510, while test sample 521 falls along the border between source region 510 and target region 520. This scenario highlights the system's ability to handle test samples originating from different regions and its effectiveness in accurately detecting anomalies.

In the case of test sample 511, scaling factors are computed for all of the reference samples in the set. The scaling factors are then applied to the distances from the reference samples to test sample 511, resulting in scaled distances. The nearest reference sample is then selected based on its scaled distance. Here, it is assumed for exemplary purposes that reference sample 513 is the nearest reference sample. As an example of how the scaling factor was computed for reference sample 513 the distances from the top 3 neighbors nearest to reference sample 513 are used to compute its scaling factor. Its scaling factor is then applied to distance 515, resulting in a scaled distance. This scaling process normalizes the distance measure, accounting for the local variability in the reference data set. By scaling the distance, the system provides a more contextually relevant measure of how anomalous the test sample is, enhancing the reliability of the detection process.

For test sample 521, which lies at the boundary between source region 510 and target region 520, scaling factors are also computed for all of the reference samples in the set. The scaling factors are then applied to the distances from the reference samples to test sample 521, resulting in scaled distances. The nearest reference sample is then selected based on its scaled distance, which is assumed here to be reference sample 523. The scaling factor for reference sample 523 was computed based on the distances of reference sample 523 to its three nearest neighbors. The scaling factor is then applied to distance 525 from reference sample 523 to test sample 521. This scaling again accounts for the potential differences between source and target domains, ensuring that the anomaly detection process remains consistent and accurate regardless of the test sample's origin.

For test sample 511, if the scaled anomaly score exceeds the threshold, it indicates a significant deviation from the normal conditions of source region 510, classifying the test sample as anomalous. Similarly, for test sample 521, if the scaled anomaly score exceeds the threshold, it signifies a significant deviation, taking into account the characteristics of both source and target regions, thus classifying the test sample as anomalous. It may be appreciated that because the scaled anomaly scores for both test samples—511 and 521—are normalized and contextually relevant, a single anomaly threshold can be used to evaluate both scores. The threshold represents the maximum acceptable deviation from normal conditions, and by applying the same threshold to both scaled anomaly scores, the system ensures consistency in anomaly detection.

Operational scenarios 500C and 500D in FIGS. 5C-5D build upon the context established in scenario 500B, featuring the same reference samples, source region, and target region, as well as the same test samples—test sample 511 and test sample 521. However, instead of using the K-nearest neighbors (K-NN) approach for computing the scaling factors for each of the reference samples, the Global Weighted Ranking Pooling (GWRP) technique is employed. This method utilizes the distances from all reference samples to a given reference sample to compute its scaling factor, which is then used to scale the distance from the reference sample to a test sample. The nearest reference sample is thus selected based on the scaled distances to the test sample.

In operational scenario 500C, the GWRP technique ensures that the distance 515 between test sample 511 and its nearest neighbor, reference sample 513, is scaled based on a scaling factor that itself is based on the inversely weighted distances of all the reference samples to reference sample 513. For instance, the distance between reference sample 517 and reference sample 513—being very close—carries a greater weight than the distances between reference sample 597 and reference sample 513, or reference sample 599 and reference sample 513, when computing the scaling factor for reference sample 513. This approach considers the relative proximities of all reference samples, thereby providing a more comprehensive context for evaluating the anomaly score.

In operational scenario 500D, the GWRP technique ensures that the distance 525 between test sample 521 and its nearest neighbor, reference sample 523, is scaled based on a scaling factor that itself is based on the inversely weighted distances of all other reference samples to reference sample 523. For instance, the distance between reference sample 527 and reference sample 523—being very close—carries a greater weight than the distances between reference sample 545 and reference sample 523, or reference sample 599 and reference sample 523, when computing the scaling factor for reference sample 523. This approach considers the relative proximities of all reference samples, thereby providing a more comprehensive context for evaluating the anomaly score.

The GWRP technique's advantage lies in its holistic approach to distance scaling. By incorporating the distances of all reference samples, the method accounts for the broader distribution and variability within the reference dataset. This results in a more accurate and contextually relevant scaling of the anomaly score. In the case of test sample 511, the scaled distance reflects not only its proximity to reference sample 513 but also the distribution of other reference samples around reference sample 513. Similarly, for test sample 521, the nearest neighbor is reference sample 523. The anomaly score for test sample 521 is its scaled distance to reference sample 523, which is scaled using scaling factor for reference sample 523 produced by the GWRP technique. This involves computing the scaling factor based on the inversely weighted distances of all other reference samples to reference sample 523. The proximity of reference samples to reference sample 523, such as those closer reference samples carrying more weight, ensures that the scaling accurately reflects the context within both the source and target regions.

These scenarios highlight the robustness and adaptability of the GWRP technique, which allows the anomaly detection system to evaluate scaled anomaly scores using a consistent threshold. By leveraging the comprehensive weighting of all reference samples, the system ensures accurate and reliable anomaly detection across different domains and regions, maintaining consistent performance and reducing the risk of false positives or false negatives.

The disclosed approach to anomaly detection, using adaptive distance normalization based on local density or ordering, has broad practical applications, especially in areas where data distributions vary widely. Some practical applications follow below.

Cybersecurity and Fraud Detection: In cybersecurity, data points (e.g., network traffic, login attempts, or transaction patterns) often vary significantly between normal and abnormal behavior. With adaptive distance normalization, a system can detect unusual patterns (like a sudden spike in login attempts from a sparse location or unexpected spending behaviors) without needing separate thresholds for different types of users or regions. This approach is particularly useful in fraud detection for finance or online transactions, where normal patterns differ by user type, location, or activity level.

Healthcare and Medical Diagnostics: Medical data often contains natural variation across patient populations (e.g., different ages, demographics, or health conditions). Adaptive normalization enables a system to detect anomalies in patient data (like unusual lab results or vital signs) while accounting for natural variability across different demographic or health-related subgroups, improving early disease detection and reducing false positives.

Industrial Equipment Monitoring: In predictive maintenance, equipment often operates under varied conditions (e.g., different load levels, environmental conditions, or usage patterns). By applying this approach, a system can detect early signs of equipment failure by identifying anomalies specific to the operational context, making it suitable for industries like manufacturing, energy, or transportation, where early detection of unusual behavior can prevent costly breakdowns.

Environmental Monitoring and Climate Science: Environmental data, like air quality or temperature readings, can vary by geographic region and time. By applying this approach, a system can detect anomalies (e.g., pollution spikes, abnormal weather patterns) within specific locations without needing separate detection thresholds for different regions. This is particularly useful for monitoring environmental health and identifying early warning signs of climate-related events.

Smart Cities and IoT Applications: In smart cities, sensors capture data on traffic, utilities, public safety, and more. Data can vary widely across neighborhoods or times of day. Adaptive distance normalization can help identify unusual patterns (e.g., spikes in energy use, traffic congestion, or crime) that deviate from local norms, enabling smarter, location-specific decision-making.

Telecommunications Network Monitoring: In telecom, network usage can vary greatly by location, user type, or time. This method allows for detection of network anomalies, like unexpected usage spikes or drops, by normalizing distances based on local network usage patterns. This helps improve quality of service, detect outages, or identify potential security breaches.

Autonomous Vehicles and Robotics: Autonomous systems operate in dynamic environments where conditions can vary drastically. Adaptive distance normalization helps in identifying anomalies in sensor data or system behaviors, accounting for varied conditions (e.g., different road types, weather, or time of day). This can improve safety and reliability in detecting obstacles or unexpected events.

For example, in industrial equipment monitoring, this adaptive anomaly detection approach can be highly effective because equipment operates under varying conditions and loads. Different embodiments apply this approach differently based on specific applications. For example:

Monitoring Context-Specific Anomalies: Equipment can have different operating states, such as idle, light load, and heavy load. Each state has its own “normal” range for factors like temperature, vibration, pressure, or energy consumption. Instead of needing separate thresholds or models for each state, this approach normalizes the distances between the test readings and historical data, making it possible to detect context-specific anomalies without explicitly classifying the state.

Handling Seasonal and Operational Variability: Industrial equipment often experiences seasonal or operational changes. For example, some equipment may run more intensively during certain months or in different parts of a plant with distinct environmental conditions. With adaptive distance normalization, the system can detect anomalies by adjusting for these variations without manually tuning the system to account for each scenario, ensuring that only truly unusual patterns stand out as anomalies.

Dealing with High- and Low-Frequency Anomalies: Anomalies in equipment monitoring can be high-frequency, like sudden spikes in vibration, or low-frequency, such as gradual increases in temperature over time. By using local density or ordered normalization, this approach can adapt to these variations, allowing the system to recognize high-frequency events in dense data clusters (like sudden shocks) and low-frequency, gradual deviations in sparse data, like gradual wear and tear.

Improving Sensitivity to Failure Patterns: Certain types of equipment failures, such as bearing degradation or motor imbalance, may produce subtle deviations that can be easily overlooked in dense operating states. Adaptive distance normalization makes it possible to detect these subtle changes because it adjusts distances based on local context. For example, if a machine's temperature gradually starts exceeding normal ranges for its current load, this method can capture the anomaly even if other readings (e.g., vibrations) remain within normal levels.

Reducing False Alarms in Noisy Environments: In industrial settings, data is often noisy due to environmental factors, sensor inaccuracies, or temporary conditions (like a power surge). By normalizing distances based on local density or order, the system can become more tolerant of noise in dense data regions, reducing false alarms when minor fluctuations occur during high-frequency operations. At the same time, in sparse regions, the method remains sensitive enough to catch anomalies in less noisy contexts.

Real-Time Anomaly Detection and Predictive Maintenance: This approach can be deployed in real-time monitoring systems to continuously assess equipment health. By dynamically adjusting distances as new data arrives, it can quickly detect deviations without needing to know the equipment's precise operating mode or external conditions. For predictive maintenance, catching these anomalies early enables operators to address potential issues before they become critical, reducing downtime and repair costs.

Aggregating Multi-Sensor Data: Industrial equipment is often monitored with multiple sensors (e.g., temperature, pressure, vibration). This method can be used to integrate readings from multiple sensors by calculating a composite distance between the test sample and the training data in a multi-dimensional feature space. By normalizing these distances for each sensor's data density or ordering, the system can detect cross-sensor anomalies that might not stand out on a single sensor reading alone. This is particularly useful for complex equipment with interconnected systems.

Application to Diverse Equipment Types: In a large industrial setting, you may have a variety of equipment with different operating conditions, from compressors and pumps to motors and turbines. This method can standardize anomaly detection across all types of equipment, as it does not require specific thresholds for each type. By normalizing distances based on the local data density or order, the method adapts automatically to each type's unique patterns, making it scalable across multiple types of machinery.

Anomaly Scoring for Maintenance Prioritization: The approach could also be used to assign an anomaly score to each equipment reading based on normalized distances. Higher scores would indicate a greater likelihood of failure, allowing maintenance teams to prioritize interventions. By normalizing based on local context, the scores would be more consistent, making it easier to identify which equipment needs urgent attention versus routine inspection.

Reduced Model Maintenance: Unlike traditional anomaly detection methods that require constant updating of separate models or thresholds for each piece of equipment and each operating condition, this approach is largely self-adaptive. The use of density or order-based distance normalization means that as new data arrives, the system continues to adapt without requiring explicit retraining or threshold adjustments, reducing the operational overhead of maintaining the monitoring system.

In such a manner, this adaptive anomaly detection method enhances industrial equipment monitoring by providing a more flexible, context-sensitive approach. It detects anomalies based on local behavior without needing detailed knowledge of operating modes, reducing false alarms and improving early detection of potential issues. This can lead to improved equipment reliability, optimized maintenance schedules, and significant cost savings in industrial operations.

It may be appreciated that, in the foregoing embodiments, scaling factors are determined for the reference data samples in a set, and the scaling factors are used to scale the distances between the reference data samples and a test data sample. The scaled distances are then used to identify the reference data sample nearest to the test data sample.

In an alternative approach, the nearest reference data sample could be selected prior to scaling its distance. That is, the unscaled distances from the reference data samples to the test data sample could be the basis for selecting the nearest reference data sample. A scaling factor could then be computed for that reference data sample using either one of the techniques disclosed herein (K-NN or GWRP). The scaling factor could then be applied to the distance from the selected reference sample and the test data sample, resulting in a scaled distance. The scaled distance may then be used to determine whether the test data sample is anomalous. Such an alternative technique would provide an advantage of having to compute fewer scaling factors (and thus, fewer scaled distances). That is, rather than having to compute a scaling factor for each reference data sample (whether at runtime or offline), only a single scaling factor need be computed—that of the reference data sample nearest to the test data sample.

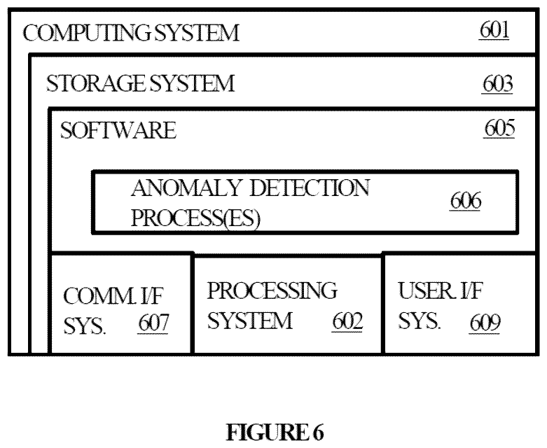

FIG. 6 illustrates computing device 601 that is representative of any system or collection of systems in which the various processes, programs, services, and scenarios disclosed herein may be implemented. Examples of computing device 601 include, but are not limited to, server computers, microcontroller units (MCUs), web servers, cloud computing platforms, and data center equipment, as well as any other type of physical or virtual server machine, container, and any variation or combination thereof. Examples may also include desktop and laptop computers, tablet computers, mobile computers, audio devices, and wearable devices (including headphones, ear buds, and the like).

Computing device 601 may be implemented as a single apparatus, system, or device or may be implemented in a distributed manner as multiple apparatuses, systems, or devices. Computing device 601 includes, but is not limited to, processing system 602, storage system 603, software 605, communication interface system 607, and user interface system 609. Processing system 602 is operatively coupled with storage system 603, communication interface system 607, and user interface system 609.

Processing system 602 loads and executes software 605 from storage system 603. Software 605 includes and implements anomaly detection process(es) 606, which is representative of the methods and processes described above. When executed by processing system 602, software 605 directs processing system 602 to operate as described herein for at least the various processes, operational scenarios, and sequences discussed in the foregoing implementations. Computing device 601 may optionally include additional devices, features, or functionality not discussed for purposes of brevity.

Referring still to FIG. 6, processing system 602 may comprise a micro-processor and other circuitry that retrieves and executes software 605 from storage system 603. Processing system 602 may be implemented within a single processing device but may also be distributed across multiple processing devices or sub-systems that cooperate in executing program instructions. Examples of processing system 602 include general purpose central processing units, graphical processing units, digital signal processors, application specific processors, and logic devices, as well as any other type of processing device, combinations, or variations thereof.

Storage system 603 may comprise any computer readable storage media readable by processing system 602 and capable of storing software 605. Storage system 603 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 603 may also include computer readable communication media over which at least some of software 605 may be communicated internally or externally. Storage system 603 may be implemented as a single storage device but may also be implemented across multiple storage devices or sub-systems co-located or distributed relative to each other. Storage system 603 may comprise additional elements, such as a controller, capable of communicating with processing system 602 or possibly other systems.

Software 605 (including anomaly detection process(es) 606) may be implemented in program instructions and among other functions may, when executed by processing system 602, direct processing system 602 to operate as described with respect to the various operational scenarios, sequences, and processes illustrated herein. For example, software 605 may include program instructions for implementing the inference, training, and anomaly detection processes described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 605 may include additional processes, programs, or components, such as operating system software, virtualization software, or other application software. Software 605 may also comprise firmware or some other form of machine-readable processing instructions executable by processing system 602.

In general, software 605 may, when loaded into processing system 602 and executed, transform a suitable apparatus, system, or device (of which computing device 601 is representative) overall from a general-purpose computing system into a special-purpose computing system customized to perform anomaly detection in an optimized manner. Indeed, encoding software 605 on storage system 603 may transform the physical structure of storage system 603. The specific transformation of the physical structure may depend on various factors in different implementations of this description. Examples of such factors may include, but are not limited to, the technology used to implement the storage media of storage system 603 and whether the computer-storage media are characterized as primary or secondary storage, as well as other factors.

For example, if the computer readable storage media are implemented as semiconductor-based memory, software 605 may transform the physical state of the semiconductor memory when the program instructions are encoded therein, such as by transforming the state of transistors, capacitors, or other discrete circuit elements constituting semiconductor memory. A similar transformation may occur with respect to magnetic or optical media. Other transformations of physical media are possible without departing from the scope of the present description, with the foregoing examples provided only to facilitate the present discussion.

Communication interface system 607 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 601 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the disclosure is not limited to the specific embodiments described above, but only by the claims and their equivalents.

What is claimed is:

1. A computer-implemented method for detecting anomalies in monitored environments, the method comprising:
collecting a test data sample from a monitored environment;
for each reference data sample of a set of reference data samples:
computing a scaling factor based at least on distances between the reference data sample and other samples of the reference data samples;
computing a scaled distance between reference data sample and a test reference sample based on the scaling factor;
identifying a nearest reference data sample, of the reference data samples, based on the scaled distance computed for each of the reference data samples; and
outputting an anomaly detection result determined based on whether the scaled distance computed for the nearest reference data sample exceeds an anomalous distance threshold.

2. The method of claim 1 wherein computing the scaled distance between the test reference sample and the reference data sample comprises:
computing a cosine distance between the test reference sample and the reference data sample; and
applying the scaling factor to the cosine distance, resulting in the scaled distance.

3. The method of claim 2 wherein the other samples comprise k-nearest neighbors of the reference data sample, and wherein computing the scaling factor based on at least the distances between the reference data sample and other samples comprises:
computing a cosine distance between the reference data sample and each of the other samples, resulting in a set of cosine distances; and
summing the cosine distances, resulting in the scaling factor.

4. The method of claim 2 wherein computing the scaling factor based on at least the distances between the reference data sample and other samples comprises:
computing a cosine distance between the reference data sample and each of the other samples, resulting in a set of cosine distances;
inversely weighting each of the cosine distances based on the cosine distance of each corresponding one of the other samples to the reference data sample, resulting in weighted cosine distances; and
summing the weighted cosine distances, resulting in the scaling factor.

5. The method of claim 1 wherein the reference data samples comprise a heterogenous dataset that includes only normal data samples and excludes any anomalous data samples, and wherein the heterogenous dataset comprises source domain data samples and target domain data samples.

6. The method of claim 5 wherein the reference data samples comprise reference embeddings produced by a machine learning model trained on the heterogenous data set to predict embeddings, and wherein the test data sample comprises a test embedding generated by the machine learning model.

7. The method of claim 6 wherein collecting the test data sample from the monitored environment comprises:
capturing characteristics of the monitored environment as signal data;
processing the signal data to extract features of the captured characteristics; and
processing the extracted features using the machine learning model to produce the test embedding.

8. The method of claim 7 wherein the captured characteristics comprise sound characteristics of the monitored environment, wherein the signal data comprises audio signal data, wherein the extracted features comprise audio features, wherein the test embedding comprises a test audio embedding, and wherein the reference embeddings comprise reference audio embeddings.

9. The method of claim 5 further comprising training the machine learning model on the heterogenous dataset to predict the embeddings.

10. The method of claim 9 wherein the heterogenous dataset comprises one or more of audio data, cybersecurity data, medical data, industrial equipment data, industrial automation data, environmental data, Internet-of-Things (IoT) data, telecommunications data, autonomous vehicle data, and robotics data.

11. A memory having program instructions stored thereon for detecting anomalies, wherein the program instructions, when executed by one or more processors of a computing device, direct the computing device to at least:
identify a test data sample associated with a monitored environment;
for each reference data sample of a set of reference data samples:
compute a scaling factor based at least on distances between the reference data sample and other samples of the reference data samples;
compute a scaled distance between reference data sample and the test reference sample based on the scaling factor;
identify a nearest reference data sample, of the reference data samples, based on the scaled distance computed for each of the reference data samples; and
output an anomaly detection result determined based on whether the scaled distance computed for the nearest reference data sample exceeds an anomalous distance threshold.

12. The memory of claim 11 wherein to compute the scaled distance between the test reference sample and the reference data sample, the program instructions direct the computing device to compute a cosine distance between the test reference sample and the reference data sample, and apply the scaling factor to the cosine distance, resulting in the scaled distance.

13. The memory of claim 12 wherein the other samples comprise k-nearest neighbors of the reference data sample, and wherein to compute the scaling factor based on at least the distances between the reference data sample and other samples, the program instructions direct the computing device to:
compute a cosine distance between the reference data sample and each of the other samples, resulting in a set of cosine distances; and
sum the cosine distances, resulting in the scaling factor.

14. The memory of claim 12 wherein to compute the scaling factor based on at least the distances between the reference data sample and other samples, the program instructions direct the computing device to:
compute a cosine distance between the reference data sample and each of the other samples, resulting in a set of cosine distances;
inversely weight each of the cosine distances based on the cosine distance of each corresponding one of the other samples to the reference data sample, resulting in weighted cosine distances; and
sum the weighted cosine distances, resulting in the scaling factor.

15. The memory of claim 11 wherein the reference data samples comprise a heterogenous dataset that includes only normal data samples and excludes any anomalous data samples, and wherein the heterogenous dataset comprises source domain data samples and target domain data samples.

16. The memory of claim 15 wherein the reference data samples comprise reference embeddings produced by a machine learning model trained on the heterogenous data set to predict embeddings, and wherein the test data sample comprises a test embedding generated by the machine learning model.

17. The memory of claim 16 wherein to identify the test data sample, the program instructions direct the computing device to:
process signal data to extract features of characteristics of the monitored environment represented in the signal data; and
process the extracted features using the machine learning model to produce the test embedding.

18. The memory of claim 17 wherein the characteristics comprise sound characteristics of the monitored environment, wherein the signal data comprises audio signal data, wherein the extracted features comprise audio features, wherein the test embedding comprises a test audio embedding, and wherein the reference embeddings comprise reference audio embeddings.

19. The memory of claim 15 wherein the heterogenous dataset comprises one or more of audio data, cybersecurity data, medical data, industrial equipment data, industrial automation data, environmental data, Internet-of-Things (IoT) data, telecommunications data, autonomous vehicle data, and robotics data.

20. A computing device comprising:
one or more computer readable storage media;
one or more processors operatively coupled with the one or more computer readable storage media; and
program instructions stored on the one or more computer readable storage media that, when executed by the one or more processors, direct the computing device to at least:
collect a test data sample from a monitored environment;
for each reference data sample of a set of reference data samples:
compute a scaling factor based at least on distances between the reference data sample and other samples of the reference data samples; and
compute a scaled distance between reference data sample and the test reference sample based on the scaling factor;
identify a nearest reference data sample, of the reference data samples, based on the scaled distance computed for each of the reference data samples; and
output an anomaly detection result determined based on whether the scaled distance computed for the nearest reference data sample exceeds an anomalous distance threshold.
